(19) United States
(12) Patent Application Publication
(10) Pub. No.: US 2006/0201614 A1
(43) Pub. Date: Sep. 14, 2006

(54) Ultraviolet protective dual layer laminate for polycarbonate resin substrates and method of manufacture thereof

(76) Inventors: Charles Mulcahy, Clarksburg, MA (US); Safwat Tadros, Evansville, IN (US); Mao Chen, Evansville, IN (US); Scott Turner, Hermosa Beach, CA (US)

Correspondence Address: CANTOR COLBURN, LLP, 55 GRIFFIN ROAD SOUTH, BLOOMFIELD, CT, 06002, US

(21) Appl. No.: 11/429,745

(22) Filed: May 8, 2006

Related U.S. Application Data
(63) Continuation of application No. 10/290,431, filed on Nov. 7, 2002.
(60) Provisional application No. 60/344,267, filed on Dec. 27, 2001.

(51) Int. Cl. B32B 37/00

(52) U.S. Cl. 156/244.11

(57) ABSTRACT

A method for producing a polycarbonate article having improved ultraviolet protection, the method comprising extruding a substrate comprising polycarbonate; impregnating an ultraviolet radiation absorber into a surface of the substrate to form an interlayer; and laminating a weatherable film onto the interlayer of the substrate. This method allows a weatherable acrylic film to be uniformly applied to the substrate to provide long term anti-yellowing performance. Articles made by this dual-layer process have excellent weathering performance for extended periods of time and can be employed in the production of commercial signs.

### CROSS-REFERENCE TO RELATED APPLICATIONS

This application is a continuation of U.S. patent application Ser. No. 10/290,431, filed on Nov. 07, 2002, which is related to and claims priority from Provisional Application No. 60/344,267 filed on Dec. 27, 2001, the entire contents of both of which are incorporated herein by reference.

### BACKGROUND OF THE INVENTION

This disclosure relates to articles comprising polycarbonate resins, and in particular to articles and methods for ultraviolet light protection of such articles.

Polycarbonate resins, are widely used as transparent glazing materials for windows, windshields, and the like. While polycarbonate resins are easily fabricated into desired shapes and have excellent physical and chemical properties, they have relatively low abrasion and chemical solvent resistance, and like many other organic polymeric materials are subject to degradation by ultraviolet radiation. Degradation of polycarbonate articles by ultraviolet radiation may occur when polycarbonate resins are used in applications that are subjected to environmental conditions, such as signs for shopping and commercial areas. Such signs, which often comprise a layer of white polycarbonate, can be particularly vulnerable to yellowing.

One approach to protecting polycarbonate articles from environmental effects and ultraviolet radiation has been to impregnate the surface of the articles with an ultraviolet light absorbing compound. However, the surface impregnation may be too thin to provide the desired long-term stability. Another approach is to co-extrude the polycarbonate article and a weatherable film. Ultraviolet light protection may be provided by incorporating an ultraviolet light absorber into the polycarbonate melt or the weatherable film, or by co-extruding an intermediate layer between the polycarbonate article and the weatherable film, wherein the intermediate layer comprises an ultraviolet light absorber. Co-extrusion, however, has several drawbacks, chief amongst them being the lack of uniformity of thickness of the weatherable film and the ultraviolet radiation-absorbing layer. This leads to sporadic yellowing as well as a shortened life for the polycarbonate article. There accordingly exists a need in the art for laminates and laminated articles wherein the thickness of the weatherable layer as well as the layer of ultraviolet radiation absorbing layer applied to the polycarbonate is uniform, thereby reducing defects.

### BRIEF DESCRIPTION OF THE FIGURES

The FIGURE is a schematic representation of a polycarbonate article, interlayer, and weatherable film.

### SUMMARY OF THE INVENTION

A method for producing a polycarbonate article having improved ultraviolet protection, comprises: impregnating an ultraviolet radiation absorber into a surface of the substrate to form an interlayer; and laminating a weatherable film onto the interlayer of the substrate.

### DETAILED DESCRIPTION OF PREFERRED EMBODIMENTS

It has been unexpectedly discovered that an article created from a laminate, wherein the laminate comprises a weatherable film applied to a substrate comprising polycarbonate resin impregnated with a uniformly thick layer of ultraviolet radiation absorbing material can withstand ultraviolet radiation without yellowing for extended periods of time. The use of a roll coater to apply the ultraviolet radiation absorbing material allows for uniform application of this layer onto the substrate. In addition, the use of a preformed weatherable film of uniform thickness applied to the coated substrate by a calendaring roll permits a laminate wherein each of the layers is substantially uniform in thickness, thereby avoiding the sporadic or spotty yellowing that is found in similar products produced by co-extrusion. This method is especially useful in producing signs for use in shopping and commercial establishments, which are continually subjected to the elements of the environment.

The polycarbonate resin comprises aromatic carbonate chain units and includes compositions having structural units of the formula (I): 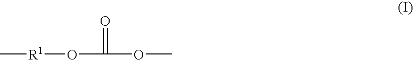
in which at least about 60 percent of the total number of R¹ groups are aromatic organic radicals and the balance thereof are aliphatic, alicyclic, or aromatic radicals. Preferably, R¹ is an aromatic organic radical and, more preferably, a radical of the formula (II):
-A¹-Y¹-A²- (II)
wherein each of A¹ and A² is a monocyclic, divalent aryl radical and Y¹ is a bridging radical having one or two atoms which separate A¹ from A². In an exemplary embodiment, one atom separates A¹ from A². Illustrative non-limiting examples of radicals of this type are —O—, —S—, —S(O)—, —S(O₂)—, —C(O)—, methylene, cyclohexyl-methylene, 2-[2.2.1]-bicycloheptylidene, ethylidene, isopropylidene, neopentylidene, cyclohexylidene, cyclopentadecylidene, cyclododecylidene, and adamantylidene. The bridging radical Y¹ can be a hydrocarbon group or a saturated hydrocarbon group such as methylene, cyclohexylidene or isopropylidene.

Polycarbonate resins can be produced by the reaction of the carbonate precursor with dihydroxy compounds. Typically, an aqueous base such as (e.g., sodium hydroxide, potassium hydroxide, calcium hydroxide, and the like,) is mixed with an organic, water immiscible solvent such as benzene, toluene, carbon disulfide, or dichloromethane, which contains the dihydroxy compound. A phase transfer resin is generally used to facilitate the reaction. Molecular weight regulators may be added to the reactant mixture. These molecular weight regulators may be added singly or as a combination. Branching resins, described forthwith may also be added singly or in admixture. Another process for producing aromatic polycarbonate resins is the transesterification process, which involves the transesterification of an aromatic dihydroxy compound and a diester carbonate. This process is known as the melt polymerization process. The process of producing the aromatic polycarbonate resins is not critical.

As used herein, the term “dihydroxy compound” includes, for example, bisphenol compounds having general formula (III) as follows: 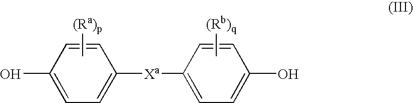
wherein R^{a} and R^{b} each represent a halogen atom, for example chlorine or bromine, or a monovalent hydrocarbon group, preferably having from 1 to 10 carbon atoms, and may be the same or different; p and q are each independently integers from 0 to 4; Preferably, X^{a} represents one of the groups of formula (IV): 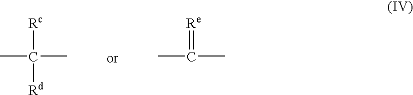
wherein R^{c} and R^{d} each independently represent a hydrogen atom or a monovalent linear or cyclic hydrocarbon group and R^{e} is a divalent hydrocarbon group.

Some illustrative, non-limiting examples of suitable dihydroxy compounds include the dihydroxy-substituted aromatic hydrocarbons disclosed by name or formula (generic or specific) in U.S. Pat. No. 4,217,438, which is incorporated herein by reference. A nonexclusive list of specific examples of the types of bisphenol compounds that may be represented by formula (III) includes 1,1-bis(4-hydroxyphenyl) methane; 1,1-bis(4-hydroxyphenyl) ethane; 2,2-bis(4-hydroxyphenyl) propane (hereinafter “bisphenol A” or “BPA”); 2,2-bis(4-hydroxyphenyl) butane; 2,2-bis(4-hydroxyphenyl) octane; 1,1-bis(4-hydroxyphenyl) propane; 1,1-bis(4-hydroxyphenyl) n-butane; bis(4-hydroxyphenyl) phenylmethane; 2,2-bis(4-hydroxy-1-methylphenyl) propane; 1,1-bis(4-hydroxy-t-butylphenyl) propane; bis(hydroxyaryl) alkanes such as 2,2-bis(4-hydroxy-3-bromophenyl) propane; 1,1-bis(4-hydroxyphenyl) cyclopentane; and bis(hydroxyaryl) cycloalkanes such as 1,1-bis(4-hydroxyphenyl) cyclohexane. Two or more different dihydric phenols may also be used.

Typical carbonate precursors include the carbonyl halides, for example carbonyl chloride (phosgene), and carbonyl bromide; the bis-haloformates, for example the bis-haloformates of dihydric phenols such as bisphenol A, hydroquinone, and the like, and the bis-haloformates of glycols such as ethylene glycol and neopentyl glycol; and the diaryl carbonates, such as diphenyl carbonate, di(tolyl) carbonate, and di(naphthyl) carbonate.

Typical branching resins such as α,α,α′,α′-tetrakis(3-methyl-4-hydroxyphenyl)-p-xylene, α,α,α′,α′-tetrakis(2-methyl-4-hydroxyphenyl)-p-xylene, α, α,α′,α′-tetrakis(2,5dimethyl-4-hydroxyphenyl)-p-xylene, α,α,α′,α′-tetrakis(2,6dimethyl-4-hydroxyphenyl)-p-xylene, α,α,α′,α′-tetrakis(4-hydroxyphenyl)-p-xylene, trimellitic acid, trimellitic anhydride, trimellitic trichloride, tris-p-hydroxy phenyl ethane, isatin-bis-phenol, tris-phenol TC (1,3,5-tris((p-hydroxyphenyl)isopropyl)benzene), tris-phenol PA (4(4(1,1-bis(p-hydroxyphenyl)-ethyl)alpha, alpha-dimethyl benzyl)phenol), 4-chloroformyl phthalic anhydride, trimesic acid, benzophenone tetracarboxylic acid and the like, can also be added to the reaction mixture. Blends of linear polycarbonate and branched polycarbonate resins can be utilized herein. The branching agent may be added at a level of about 0.05 to about 2.0 weight percent (wt %).

Some illustrative, non-limiting examples of suitable phase transfer resins include, but are not limited to, tertiary amines such as triethylamine, quaternary ammonium compounds, and quaternary phosphonium compounds.

Molecular weight regulators or chain stoppers are optional and are added to the mixture in order to arrest the progress of the polymerization. Typical molecular weight regulators such as phenol, chroman-1, p-t-butylphenol, p-bromophenol, para-cumyl-phenol, and the like may be added either singly or in admixture and are generally added in an amount of about 1 to about 10 mol % excess with respect to the BPA. The molecular weight of the polycarbonate resin is generally greater than or equal to about 5000, preferably greater than or equal to about 10,000, more preferably greater than or equal to about 15,000 g/mole. In general it is desirable to have the polycarbonate resin less than or equal to about 100,000, preferably less than or equal to about 50,000, more preferably less than or equal to about 30,000 g/mole as calculated from the viscosity of a methylene chloride solution at 25° C.

The polycarbonate resin may, optionally, further comprise one or more other thermoplastic resins in addition to the aromatic polycarbonate resin, such as, for example, polyphenylene ether resins, vinyl aromatic graft copolymer resins, styrenic resins, polyester resins, polyamide resins, polyesteramide resins, polyetheresteramide resins, vinyl aromatic graft copolymer such as acrylonitrile-butadiene-styrene, polysulfone resins, polyimide resins, and polyetherimide resins. In another embodiment, in the event that a blend of the polycarbonate resin with an optional polyester or any of the other above listed thermoplastic resins is employed as the substrate, it is then desirable for the polycarbonate resin to be present in an amount greater than or equal to about 30, preferably greater than or equal to about 40 wt % of the substrate composition. It is also desirable for the polycarbonate resin to be present in an amount of about 100, preferably less than or equal to about 90, more preferably less than or equal to about 80 wt % of the substrate composition.

The polycarbonate resin or polycarbonate resin blend is generally extruded in the form of a sheet. The thickness of the sheet is greater than or equal to about 0.5, preferably greater than or equal to about 100, more preferably greater than or equal to about 200, most preferably greater than or equal to about 1000 microns. In general it is desirable for the sheet to have a thickness less than or equal to about 15 millimeters (mm), preferably less than or equal to about 12 mm, more preferably less than or equal to about 10 mm (10,000 microns).

The ultraviolet radiation absorbers for use in the invention have the ability to screen out the damaging ultraviolet portion of light. These compounds include the benzophenones, benzotriazoles, benzoate esters, phenyl salicylates, crotonic acid, malonic acid esters, cyanoacrylates, derivatives, and combinations comprising any one of the foregoing ultraviolet radiation absorbers.

Included among the ultraviolet radiation absorbers, which fall into the categories of benzophenone derivatives and benzotriazole derivatives are those compounds disclosed in U.S. Pat. Nos. 3,309,220, 3,049,443 and 2,976,259, all of which are herein incorporated by reference. Some non-limiting examples of these compounds include: 2,2′-dihydroxybenzophenone, 2,2′,4,4′-tetrahydroxybenzophenone, 2,2′-dihydroxy-4,4′-dimethoxybenzophenone, 2,2′-dihydroxy-4,4′-diethoxybenzophenone, 2,2′-dihydroxy-4,4′-dipropoxybenzophenone, 2,2′-dihydroxy-4,4′-dibutoxybenzophenone, 2,2′-dihydroxy-4-methoxy-4′-ethoxybenzophenone, 2,2′-dihydroxy-4-methoxy-4′-propoxybenzophenone, 2,2′-dihydroxy-4-methoxy-4′-butoxybenzophenone, 2,2′-dihydroxy-4-ethoxy-4′-propoxybenzophenone, 2,2′-dihydroxy-4-ethoxy-4′-butoxybenzophenone, 2,3′-dihydroxy-4,4′-dimethoxybenzophenone, 2,3′-dihydroxy-4-methoxy-4′-butoxybenzophenone, 2-hydroxy-4,4′,5′-trimethoxybenzophenone, 2-hydroxy-4,4′,6′-tributoxybenzophenone, 2-hydroxy-4-butoxy-4′,5′-dimethoxybenzophenone, 2-hydroxy-4-ethoxy-2′,4′-dibutylbenzophenone, 2-hydroxy-4-propoxy-4′,6′-dichlorobenzophenone, 2-hydroxy-4-propoxy-4′,6′-dibromobenzophenone, 2,4-dihydroxybenzophenone, 2-hydroxy-4-methoxybenzophenone, 2-hydroxy-4-ethoxybenzophenone, 2-hydroxy-4-propoxybenzophenone, 2-hydroxy-4-butoxybenzophenone, 2-hydroxy-4-methoxy-4′-methylbenzophenone, 2-hydroxy-4-methoxy-4′-ethylbenzophenone, 2-hydroxy-4-methoxy-4′-propylbenzophenone, 2-hydroxy-4-methoxy-4′-butylbenzophenone, 2-hydroxy-4-methoxy-4′-tertiarybutylbenzophenone, 2-hydroxy-4-methoxy-4′-chlorobenzophenone, 2-hydroxy-4-methoxy-2′-chlorobenzophenone, 2-hydroxy-4-methoxy-4′-bromobenzophenone, 2-hydroxy-4,4′-dimethoxybenzophenone, 2-hydroxy-4,4′-dimethoxy-3-methylbenzophenone, 2-hydroxy-4,4′-dimethoxy-2′-ethylbenzophenone, 2-hydroxy-4,4′,5′-trimethoxybenzophenone, 2-hydroxy-4-ethoxy-4′-methylbenzophenone, 2-hydroxy-4-ethoxy-4′-ethylbenzophenone, 2-hydroxy-4-ethoxy-4′-propylbenzophenone, 2-hydroxy-4-ethoxy-4′-butylbenzophenone, 2-hydroxy-2-hydroxy-4-ethoxy-4′-propoxybenzophenone, 2-hydroxy-4-ethoxy-4′-butoxybenzophenone, 2-hydroxy-4-ethoxy-4′-chlorobenzophenone, 2-hydroxy-4-ethoxy-4′-bromobenzophenone, 2-(2′-hydroxy-5′-methylphenyl)-benzotriazole, 2-(2′-hydroxy-5′-tert-butylphenyl)-benzotriazole, 2-(2′-hydroxy-3 ′-methyl-5′-tert-butylphenyl)-benzotriazole, 2-(2′-hydroxy-5′-cyclohexylphenyl)-benzotriazole, 2-(2′-hydroxy-3′,5′-dimethylphenyl)-benzotriazole, 2-(2′-hydroxy-5′-tert-butylphenyl)-5-chlorobenzotriazole, 2-(2′-hydroxy-3′-di-tert-butylphenyl)-benzotriazole, 5-trifluoromethyl-2-(2-hydroxy-3α-cumyl-5-tert-octylphenyl)-2H-benzotriazole, 5-trifluoromethyl-2-(2-hydroxy-5-tert-octylphenyl)-2H-benzotriazole, 5-trifluoromethyl-2-(2-hydroxy-3,5-di-tert-octylphenyl)-2H-benzotriazole, 2′-methylene-bis [6-(5-trifluoromethyl-2H-benzotriazol-2-yl)-4-tert-octylphenol], methylene-2-[4-tert-octyl-6-(2H-benzotriazol-2-yl) phenol]2′-[4-tert-octyl-6-(5-trifluoromethyl-2H-benzotriazol-2-yl)phenol], 3-(5-trifluoromethyl-2H-benzotriazol-2-yl)-5-tert-butyl-4-hydroxyhydrocinnamic acid, methyl 3-(5-trifluoromethyl-2H-benzotriazol-2-yl)-5-tert-butyl-4-hydroxyhydrocinnamate, isooctyl 3-(5-trifluoromethyl-2H-benzotriazol-2-yl)-5-tert-butyl-4-hydroxyhydrocinnamate, 5-trifluoromethyl-2-[2-hydroxy-5-(3-hydroxypropyl)phenyl]-2H-benzotriazole, 5-butylsulfonyl-2-(2-hydroxy-3-α-cumyl-5-tert-octylphenyl)-2H-benzotriazole, 5-octylsulfonyl-2-(2-hydroxy-3,5-di-tert-cumylphenyl)-2H-benzotriazole, 5-dodecylsulfonyl-2-(2-hydroxy-3,5-di-tert-butylphenyl)-2H-benzotriazole, 5-octylsulfonyl-2-(2-hydroxy-3,5-di-tert-octylphenyl)-2H-benzotriazole, 5-trifluoromethyl-2-(2-hydroxy-3-tert-cumyl-5-tert-butylphenyl)-2H-benzotriazole, 5-trifluoromethyl-2-(2-hydroxy-3-α-cumyl-5-nonylphenyl)-2H-benzotriazole, 5-trifluoromethyl-2-[2-hydroxy-3-α-cumyl-5-(2-hydroxyethyl)phenyl]-2H-benzotriazole, 5-trifluoromethyl-2-[2-hydroxy-3-α-cumyl-5-(3-hydroxypropyl)phenyl]-2H-benzotriazole, 5-trifluoromethyl-2-(2-hydroxy-3,5-di-tert-amylphenyl)-2H-benzotriazole, 5-trifluoromethyl-2-(2-hydroxy-3,5-di-tert-butylphenyl)-2H-benzotriazole, 5-trifluoromethyl-2-(2-hydroxy-3-dodecyl-5-methylphenyl)-2H-benzotriazole, 5-trifluoromethyl-2-[2-hydroxy-3-tert-butyl-5-(3-hydroxypropyl)phenyl]-2H- benzotriazole, 5-trifluoromethyl-2-[2-hydroxy-3-tert-butyl-5-(2-hydroxyethyl)phenyl]-2H-benzotriazole, 5-trifluoromethyl-2-[2-hydroxy-5-(2-hydroxyethyl)phenyl]-2H-benzotriazole, 5-trifluoromethyl-2-(2-hydroxy-3,5-di-α-cumylphenyl)-2H-benzotriazole, 5-fluoro-2-(2-hydroxy-3,5-di-α-cumylphenyl)-2H-benzotriazole, 5-butylsulfonyl-2-(2-hydroxy-3,5-di-α-cumylphenyl)-2H-benzotriazole, 5-butylsulfonyl-2-(2-hydroxy-3,5-di-tert-butylphenyl)-2H-benzotriazole, 5-butylsulfonyl-2-(2-hydroxy-3,5-di-tert-octylphenyl)-2H-benzotriazole, 5-phenylsulfonyl-2-(2-hydroxy-3,5-di-tert-butylphenyl)-2H-benzotriazole, or 5-chloro-2-(2-hydroxy-3,5-di-a-cumylphenyl)-2H-benzotriazole.

Two non-limiting examples of the derivatives of crotonic acid which function as ultraviolet radiation absorbers are α-cyano-β-(p-methoxyphenyl)-crotonic acid methyl ester and α-cyano-β-N-(2-methyl-indolinyl)-crotonic acid methyl ester. The benzoate ester ultraviolet radiation absorbing compounds include the C₈-C₂₀ alkyl and aryl benzoates, alkyl and aryl hydroxybenzoates, alkaryl and aralkyl benzoates, and aralkyl and alkaryl hydroxybenzoates.

The malonic acid esters, which are effective ultraviolet radiation absorbers, include the benzylidene malonates. These benzylidene malonates are represented by the general formula (V) 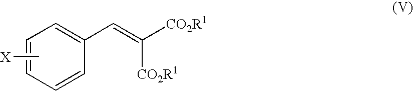
wherein X is selected from hydrogen, hydroxyl, halogen, alkyl, preferably C₁-C₁₀ alkyl, and alkoxy, preferably C₁-C₁₀ alkoxy, radicals; and R and R¹ are independently selected from alkyl radicals, preferably alkyl radicals containing from about 1 to about 10 carbon atoms, substituted alkyl radicals, preferably those containing from about 1 to about 10 carbon atoms and hydroxyl or halogen substituents, aryl radicals, preferably the phenyl radical, alkaryl radicals, preferably those alkaryl radicals containing from about 7 to about 12 carbon atoms, aralkyl radicals, preferably aralkyl radicals containing from about 7 to about 12 carbon atoms, and substituted aryl radicals, preferably phenyl radicals containing hydroxyl or halogen substituents. Preferred benzylidene malonates represented by formula I are those wherein X represents an alkoxy group and R and R¹ are independently selected from alkyl radicals. Examples of these benzylidene malonates include diethyl paramethoxybenzylidene malonate and dimethyl paramethoxybenzylidene malonate.

Among the cyanoacrylates, which are useful ultraviolet radiation, absorbers are those cyanoacrylates represented by the general formula (VI) 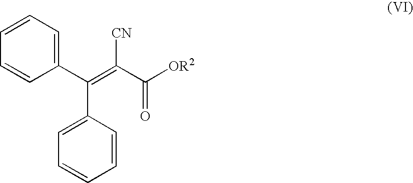
wherein R² is alkyl or hydroxyalkyl. These compounds are disclosed in U.S. Pat. No. 4,129,667, which is incorporated herein by reference.

In one embodiment of the invention, the ultraviolet radiation absorbing compounds are the benzophenone derivatives, the benzotriazole derivatives, the benzylidene malonates, and the cyanoacrylates. In another embodiment, commercially available ultraviolet radiation absorbers are used, including “UVINUL” 400 (2,4-dihydroxybenzophenone manufactured by BASF Corp.), “UVINUL” D 49 (2,2′-dihydroxy-4,4′-dimethoxybenzophenone manufactured by BASF Corp.), “UVINUL” N 35 (ethyl-2-cyano-3,3-diphenylacrylate manufactured by BASF Corp.), “UVINUL” N 539 (2-ethylhexyl-2-cyano-3,3′-diphenylacrylate manufactured by BASF Corp.) “UVINUL” M 40 (2-hydroxy-4-methoxybenzophenone manufactured by BASF Corp.) “UVINUL” M 408 (2-hydroxy-4-octoxybenzophenone manufactured by BASF Corp.) “TINUVIN” P (2-(2′-hydroxy-5′-methylphenyl)-triazole manufactured by Ciba Geigy Corp.), “TINUVIN” 327 [2-(3′,5′-di-t-butyl-2′-hydroxyphenyl)-5-chloro-benzotriazole manufactured by Ciba Geigy Corp.), “TINUVIN” 328 [2-(3′,5′-di-n-pentyl-2′-hydroxyphenyl)-benzotriazole manufactured by Ciba Geigy Corp.), and “CYASORB UV” 24 (2,2′-dihydroxy-4-methoxy-benzophenone manufactured by American Cyanamid Co.).

The ultraviolet radiation absorber may be applied as an interlayer to the substrate by several different methods such as roll coating, dip coating, flow coating, or spraying. A doctor blade may be used to increase the uniformity of the interlayer applied to the substrate. The ultraviolet radiation absorber may be applied to the substrate either in the pure form or as a solution in a carrier. It is preferable for the ultraviolet radiation absorber to be dispersed in a carrier and applied to the substrate in a roll coater. The ultraviolet radiation absorber solution can alternately be allowed to continuously drip onto one of the rolls of the roll coater and subsequently be applied to the substrate. By applying the solution to the rolls, it is allowed to spread out uniformly across the rolls and is therefore uniformly applied to the substrate. The ultraviolet radiation absorber is impregnated into the surface of the substrate during the process of lamination.

In one embodiment of the invention, the carrier is a solvent for the ultraviolet radiation absorber as well as for the substrate so as to facilitate some dissolution of the ultraviolet radiation absorber into the substrate. The carrier may be chosen from amongst a wide variety of liquids, common examples among these being, toluene, acetone, methyl ethyl ketone, methyl isobutyl ketone, methylene chloride, chloroform, water, alcohols such as methanol, ethanol and isopropyl alcohol and the like. When the ultraviolet radiation absorber is dispersed in a carrier, the absorber is present in an amount of greater than or equal to about 5, preferably greater than or equal to about 10, more preferably greater than or equal to about 15 wt % of the total weight of the ultraviolet radiation absorber and the carrier. It is also desirable for the ultraviolet radiation absorber to be present in an amount of less than or equal to about 95, preferably less than or equal to about 90, more preferably less than or equal to about 85 wt % of the total weight of the ultraviolet radiation absorber and the carrier. The thickness of the ultraviolet radiation absorber is generally greater than or equal to about 0.1, preferably greater than or equal to about 0.5, more preferably greater than or equal to about 1, most preferably greater than or equal to about 2 microns. It is generally desirable for the thickness of the ultraviolet radiation absorber to be less than or equal to about 100, preferably less than or equal to about 75, more preferably less than or equal to about 50, most preferably less than or equal to about 40 microns.

The amount of ultraviolet radiation absorber applied to and impregnated into the surface of the substrate is an amount effective to protect the substrate against degradation by ultraviolet radiation. Either a single ultraviolet radiation absorber or a mixture of ultraviolet radiation absorbers may be impregnated into the surface of the substrate comprising polycarbonate. Generally, a sufficient amount of ultraviolet absorber is present in the surface layers of the polycarbonate resin article so as to absorb at least 90% of the incident ultraviolet radiation on the polycarbonate surface layers.

The weatherable film, which is laminated onto the substrate, may comprise a polymeric material that is capable of providing weather resistance and that will not significantly fade, peel, chalk, or crack when exposed to the environment for the intended life of the product. The weatherable film may be monolayer or multilayer. A number of known testing procedures, in which objects are exposed to either the natural environment over an extended time or a harsh artificial environment for a short time, are used to determine the weatherability of polymers. Such weatherable polymers include acrylate polymers, fluoropolymers, urethane polymers, silicone polymers and blends thereof.

Useful acrylate polymers are obtained from a variety of acrylic monomers, such as acrylic and methacrylic acids, and their amides, esters, salts, and corresponding nitriles. Particularly suitable monomers for such polymers are methyl methacrylate, ethyl acrylate, and acrylonitrile. The polymers may each be used in the form of homopolymers, or with various other monomers, which can be copolymerized therewith. Additional illustrative examples of acrylate polymers are thermoplastic polyacrylates and polymethacrylates which are homopolymers and copolymers of acrylic acid ester and methacrylic acid ester, such as, for example, polyacrylic acid isobutyl ester, polymethacrylic acid methyl ester, polymethacrylic acid ethylhexyl ester, polyacrylic acid ethyl ester; copolymers of various acrylic acid esters and/or methacrylic acid esters, such as, for example, methacrylic acid methyl ester/acrylic acid cyclohexyl ester copolymers; and copolymers of acrylic acid esters and/or methacrylic acid esters with styrene and/or alpha-methylstyrene, as well as the graft polymers and copolymers and polymer mixtures composed of acrylic esters, methacrylic acid esters, styrene and butadiene. A group of transparent, weatherable blends of acrylate polymers and polyvinylidene fluoride polymers can be used in the weatherable film and are disclosed in U.S. Pat. No.3,524,906, which is incorporated herein by reference.

Commercially available acrylic materials, which can be used for weatherable films, are PLEXIGLAS resin available from Rohm & Haas, PERSPEX CQ resin available from Goodfellow, KORAD film available from Polymer Extruded Products.

Useful fluoropolymers include polymers-and copolymers formed from monomers trifluoroethylene, tetrafluoroethylene, hexafluoropropylene, monochlorotrifluoroethylene and dichlorodifluoroethylene. Copolymers and terpolymers of these monomers formed from fluoroolefins such as vinylidene fluoride are also useful. Further illustrative examples of fluoropolymers include polyvinyl fluoride, polyvinylidene fluoride, fluorinated ethylene/propylene copolymers, ethylene/chlorotrifluoroethylene copolymers, vinylidene fluoride/hexafluoropropene copolymers, and vinylidene fluoride/perfluoro (alkyl vinyl ether) dipolymers and terpolymers with tetrafluoroethylene. Commercially available fluoropolymer resins suitable for use as weatherable films are those sold under trademarks such as KYNAR, FORAFLON, SOLEF, LUMIFLON, and TEFLON. Blends, alloys and copolymers of acrylate polymers with fluoropolymers can also be used. An illustrative weatherable film of an alloy of an acrylate polymer and polyvinylidene fluoride is FLUOREX manufactured by Rexham Corporation.

Useful urethane polymers are prepared by reacting a polyisocyanate with a compound containing at least two active hydrogen atoms, such as a polyol, a polyamine, or a polyisocyanate. Polyurethane resins can be selected from resins in which the reactants have been chosen to provide weatherable, thermoformable polymers. Numerous suitable polyurethane resins are available. Generally, aromatic polyisocyanates tend to yellow, and aliphatic polyisocyanates are more preferred.

In one embodiment the weatherable film may be a silicone film. Copolymers of silicones with acrylates such as polymethylmethacrylate polysiloxane block copolymers polyurethane polysiloxane and polyester and polycarbonate block copolymers comprising polysiloxanes may also be used.

The outer weatherable layer may be made from various weather resistant polymer blends such as, for example ethylene/propylene/nonconjugated diene-reinforced styrene/acrylonitrile copolymers (AES) or butyl acrylate-reinforced styrene/acrylonitrile copolymer (ASA), styrene acrylonitrile (SAN) or mixtures thereof and any of the foregoing weather resistant polymer materials blended with poly vinyl chloride (PVC), chlorinated polyethylene (CPE), aliphatic polyurethane, saturated styrenic block copolymers or mixtures of PVC and CPE. Commercially available resin blends, which can be used as weatherable films include, for example, ROVEL available from Dow Chemical Company, ASA-type resins such as GELOY commercially available from General Electric Corporation or CENTREX commercially available from Bayer Corp., stabilized polyvinyl chloride (PVC) such as DURACAP and GEON commercially available from BF Goodrich.

The weatherable film may also include blends of an AES or ASA-type resin blended with an elastomer. The elastomer can be, for example, an elastomer that is compatible with the AES and ASA resin and is weatherable. The elastomer may be selected from the group comprising chlorinated polyethylene, aliphatic urethane, and saturated styrenic block copolymers. The use of the blend composition advantageously improves the stress whitening resistance of the AES and ASA-type weatherable films. The blend can be used in applications wherein stress whitening is likely to occur, for example, in applications where the film is required to bend at some radius of a part being covered, since stress whitening usually occurs at the bend creating an undesirable color change; or in applications in which the substrate is subject to dimensional instability, such as occurs with thermally induced expansion and contraction of the substrate.

The elastomer employed in the weatherable thermoplastic composition blend is preferably present in an amount of greater than or equal to about 10 wt % of the total weight of the weatherable film. In general it is desirable to have elastomer present in an amount of less or equal to about 50, preferably less than or equal to about 35 wt % of the total weight of the weatherable film.

The weatherable film may also contain commonly used additives such as antioxidants, antiozonants, flame-retardants, ultraviolet stabilizers, ultraviolet radiation absorbers such as those described above. Generally, the ultraviolet stabilizers are present in the weatherable film in amounts of about 0.5 wt % to about 5 wt % of the total weight of the weatherable film. The weatherable film generally has a thickness greater than or equal to about 10, preferably greater than or equal to about 20, more preferably greater than about 30 microns. In general, it is desirable for the weatherable film to have a thickness less than or equal to about 300, preferably less than or equal to about 175, more preferably less than or equal to about 150 microns.

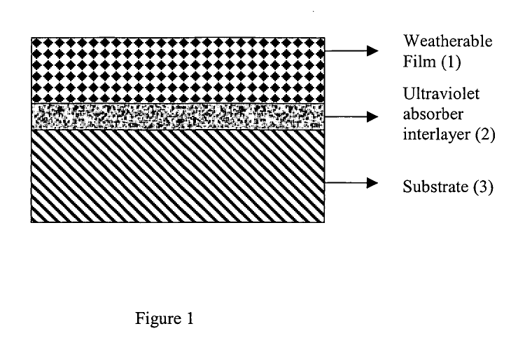

In the process of producing such ultraviolet protected laminates, the extruded substrate comprising polycarbonate of desired thickness is coated with the desired ultraviolet radiation absorber at a temperature sufficient to permit impregnation of the absorber into the substrate. The substrate comprising polycarbonate is first extruded and further processed by the roll stack in the form of a sheet, film or slab. The substrate emanating from the roll stack then passes through a roll coater where the ultraviolet radiation absorber is applied to the substrate. This is accomplished by placing the coating solution containing the ultraviolet radiation absorber on one of the rolls of the roll coater. The ultraviolet radiation absorber solution can alternately be allowed to continuously drip onto one of the rolls of the roll coater and subsequently be applied to the substrate. By applying the solution to the rolls, it is allowed to spread out uniformly across the rolls and is therefore uniformly applied to the substrate. The application of a uniform coating to the substrate is highly desirable. During the process of roll coating, the temperature of the rolls may be set at any desired value so as to facilitate impregnation of the substrate with the ultraviolet radiation absorber. Following roll coating, the substrate passes through an oven where it is heated to a temperature effective to remove all solvents from the ultraviolet radiation absorber coating. The coated substrate then passes through the laminator rolls of a calendaring roll stack where the weatherable film is laminated onto the substrate. The speed of the calendaring roll stack is adjusted to deliver the plastic sheet at a uniform rate to match the roll coat and online lamination process. To achieve high quality surface finish of product, proper lamination temperature and a polished chrome roll are critical. The laminated substrate prepared by this method can be protected from yellowing for extended periods of time. This method allows for a very thin weatherable film to be applied onto the substrate as shown in FIG. 1. Product from this dual layer process will provide excellent weathering performance, anti-yellow performance and low initial color without affecting the overall physically properties of the polycarbonate substrate. As stated above, products from this process may be used in the manufacture of commercial signs for shops and businesses.

A sample comprised a surface impregnated, 3,175 micron thick, polycarbonate sheet with Korad acrylic film laminated onto it. The Korad acrylic film is an ultraviolet stabilized acrylic weatherable film from Polymer Extruded Products with a thickness of 100 to 150 microns and is laminated onto the polycarbonate sheet in the calendaring roll stack. The surface was impregnated with ultraviolet radiation absorber comprising a benzotriazole called Tinuvin 213, obtained from Ciba Speciality Chemicals. The ultraviolet radiation absorber was mixed with a solvent such as toluene. The process of impregnation resulted in a coating of fairly uniform thickness of about 3 to about 30 microns on the extruded substrate. The substrate comprising polycarbonate with the ultraviolet radiation absorber impregnated into the surface is then passed through an oven set at a temperature sufficient to evaporate the solvent. The speed of the calendaring roll stack is adjusted to deliver the plastic sheet at a uniform rate to match the roll coat and online lamination process.

The weathering performance of the sample was evaluated using a Q-Panel QUVB (313 lamps) accelerated weathering chamber manufactured by Q Panel Lab Products, Inc. The weathering cycle of this QULTRAVIOLETB test consists of 8 hours of a light cycle at 60° C. followed by 4 hours of a condensation cycle at 40° C. Yellowness index was recorded on a Macbeth 7000A Colorimeter.

The results show that, after 6,000 hours of testing, the sample had a small change in yellowness index; namely 6.1, with a mere change of 1.6 after 1,500 hours. This is a synergistic effect of using the surface impregnation in conjunction with the weatherable film. The method allows a weatherable film to be uniformly applied to the substrate to provide long term anti-yellowing performance. Articles made by this dual-layer process have excellent weathering performance for extended periods of time and can be employed in the production of commercial signs.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention.

1. A method for producing a polycarbonate article, the method comprising
extruding a substrate comprising polycarbonate;
impregnating an ultraviolet radiation absorber into a surface of the substrate to form an interlayer; and
laminating a weatherable film onto the interlayer of the substrate.

2. The method of claim 1, wherein the ultraviolet radiation adsorber is disposed with a roll coater.

3. The method of claim 1, wherein laminating is in a calendaring roll mill.

4. The method of claim 1, further comprising heating the substrate prior to laminating.

5. The method of claim 1, wherein the substrate has a thickness of about 0.5 microns to about 15 mm.

6. The method of claim 1, wherein the substrate further comprises a resin selected from the group consisting of polyphenylene ether resins, vinyl aromatic graft copolymers resins, styrenic resins, polyester resins, polyamide resins, polyesteramide resins, polysulfone resins, polyimide resins, and polyetherimide resins and mixtures comprising at least one of the foregoing resins.

7. The method of claim 1, wherein the ultraviolet radiation absorber is selected from the group consisting of benzophenone derivatives, benzotriazole derivatives, benzylidene malonates, cyanoacrylates, and combinations comprising at least one of the foregoing ultraviolet radiation absorbers.

8. The method of claim 1, wherein the weatherable film is selected from the group consisting of fluoropolymers, acrylate polymers, urethane polymers, silicone polymers, and combinations comprising at least one of the foregoing polymers.

9. The method of claim 1, wherein the weatherable film is an acrylate polymer formed from a monomer selected from the group consisting of acrylic acid, methacrylic acid, amides of acrylic acid, amides of methacrylic acid, esters of acrylic acid, esters of methacrylic acid, salts of acrylic acid, salts of methacrylic acid, nitriles of acrylic acid, nitriles of methacrylic acids, and combinations comprising at least one of the foregoing monomers.

10. The method of claim 9, wherein the acrylate polymer is selected from the group consisting of polyacrylic acid isobutyl ester, polymethacrylic acid methyl ester, polymethacrylic acid ethylhexyl ester, polyacrylic acid ethyl ester, copolymers of acrylic acid esters and methacrylic acid esters, ethylene/propylene/nonconjugated diene-reinforced styrene/acrylonitrile copolymers, butyl acrylate-reinforced styrene/acrylonitrile copolymer, styrene acrylonitrile and combinations comprising at least one of the foregoing acrylate polymers.

11. The method of claim 1, wherein the weatherable film is a fluoropolymer formed from a monomer selected from the group consisting of trifluoroethylene, tetrafluoroethylene, hexafluoropropylene, monochlorotrifluoroethylene, dichlorodifluoroethylene, and combinations comprising at least one of the foregoing fluoropolymers.

12. The method of claim 11, wherein the fluoropolymer is selected from the group consisting of polyvinyl fluoride, polyvinylidene fluoride, fluorinated ethylene/propylene copolymers, ethylene/chlorotrifluoroethylene copolymers, vinylidene fluoride/hexafluoropropene copolymers, vinylidene fluoride/perfluoro alkyl vinyl ether, dipolymers and terpolymers with tetrafluoroethylene, and combinations comprising at least one of the foregoing fluoropolymers.

13. The method of claim 1, wherein the weatherable film is a polyurethane derived from a reaction between a polyol and a polyisocyanate.

14. The method of claim 13, wherein the polyisocyanate is aliphatic.

15. The method of claim 1, wherein the substrate is extruded in the form of a sheet, slab or film.

16. The method of claim 1, wherein the weatherable film comprises an ultraviolet stabilizer.

17. A method for producing an article having ultraviolet protection, the method comprising:
extruding a polycarbonate substrate;
disposing a layer of benzotriazole onto the substrate in a roll coater to provide a coated substrate; and
laminating a weatherable film comprising an ultraviolet light stabilizer onto the coated surface of the substrate in a calendaring roll mill.

18. The method of claim 17, wherein a thickness of the substrate is about 1,000 to about 10,000 microns.

19. The method of claim 17, wherein a thickness of the benzotriazole layer is about 0.1 to about 100 microns.

20. The method of claim 19, wherein the thickness of the benzotriazole layer is about 0.5 to about 50 microns.

21. A method for producing a polycarbonate article, the method comprising:
extruding a substrate comprising polycarbonate;
impregnating an ultraviolet radiation absorber into a surface of the substrate to form an interlayer, wherein the ultraviolet radiation absorber is selected from the group consisting of benzophenone derivatives, benzotriazole derivatives, benzylidene malonates, cyanoacrylates, and combinations comprising at least one of the foregoing ultraviolet radiation absorbers; and
laminating a weatherable film onto the interlayer of the substrate, wherein the weatherable film is an acrylate polymer formed from a monomer selected from the group consisting of acrylic acid, methacrylic acid, amides of acrylic acid, amides of methacrylic acid, esters of acrylic acid, esters of methacrylic acid, salts of acrylic acid, salts of methacrylic acid, nitrites of acrylic acid, nitrites of methacrylic acids, and combinations comprising at least one of the foregoing monomers.

22. The method of claim 21, wherein the weatherable film comprises an acrylate polymer.

23. A method for producing a polycarbonate article, comprising:
extruding a substrate comprising polycarbonate;
impregnating an ultraviolet radiation absorber into a surface of the substrate to form an interlayer; and
disposing a weatherable film onto the surface using a calendaring roll mill.

24. The method of claim 23, wherein the weatherable film comprises an acrylate polymer.

25. A method for producing a polycarbonate article, comprising:
forming a solution of a ultraviolet radiation absorber and a solvent;
impregnating the solution into a surface of a polycarbonate substrate;
removing the solvent from the surface; and
disposing a weatherable film onto the surface using a calendaring roll mill.

26. The method of claim 25, wherein the weatherable film comprises an acrylate polymer.
